(19) United States
(12) Patent Application Publication
(10) Pub. No.: US 2008/0284355 A1
(43) Pub. Date: Nov. 20, 2008

(54) Method and Driving Circuit for Operating a Hid Lamp

(75) Inventors: Ronald Hans Van Der Voort, Eindhoven (NL); Winston Donald Couwenberg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,891

(22) PCT Filed: Jun. 9, 2005
(86) PCT No.: PCT/IB2005/051905

§ 371 Date: Dec. 19, 2006

(30) Foreign Application Priority Data
Jun. 21, 2004 (EP) 04102822.6

(51) Int. Cl. H05B 41/36

(52) U.S. Cl. 315/307

(57) ABSTRACT

To avoid acoustic resonance in a gas discharge lamp, a lamp current constituted of a number of frequencies is supplied to said lamp. Using a number of frequencies, the total power supplied to the lamp is distributed over said number of frequencies. Since the power per frequency is relatively low, the possibility of occurrence of an acoustic resonance is low irrespective of the characteristics of the gas discharge lamp. The current may comprise a number of frequencies by applying a number of sinusoidal currents or by using a non-sinusoidal current.

The present invention relates to a method and driving circuit for operating a high-intensity discharge (HID) lamp, in particular for operating a HID lamp using a current comprising a number of frequency components to avoid acoustic resonance in said lamp.

Gas discharge lamps operated at high frequency are susceptible to acoustic resonances. Standing pressure waves in the lamp can cause the arc to become distorted, to move the arc from side to side, creating an annoying flicker, or in severe cases even to destroy the lamp.

A known solution to the problem of occurring acoustic resonances is to use a non-constant lamp current frequency, e.g. by applying frequency modulation, to spread the power across various frequencies such that the power in each frequency is too low to generate an acoustic wave.

Another known solution to the problem is to operate the lamp in a very high frequency (VHF) range. With a very high frequency is meant a frequency above the acoustic resonance range. Possibly still occurring acoustic resonances are sufficiently damped in this frequency range to keep the arc stable.

However, operating a gas discharge lamp at a predetermined VHF frequency may still result in a visible acoustic resonance. At the predetermined VHF frequency, some lamps may be instable due to a difference in gas mixture, production tolerances, or changes during use over lifetime.

Applying a frequency modulation requires additional circuitry to obtain the modulation, resulting in undesirable large and expensive lamp driving circuits.

Operating a gas discharge lamp in an even higher frequency range than the VHF range, i.e. an extreme high frequency (EHF) range, results in high power losses and control problems of the lamp driving circuit, and thus it is no practical solution to the problems described above.

Further, it is known that operating the gas discharge lamp at a frequency below the acoustic resonance frequency range still results in acoustic resonance generated by higher order harmonics of the operating frequency.

It is an object of the present invention to provide a gas discharge lamp driving method and circuit, which minimize the occurrence of acoustic resonances in the gas discharge lamp.

The above object is achieved by a method of operating a gas discharge lamp by supplying a current to the gas discharge lamp, a frequency of said current being constant and lying in a predetermined high or very high frequency range, characterized in that the current comprises a number of frequencies in said frequency range, an input power being distributed across said number of frequencies in said predetermined, high or very high frequency range.

Further, the present invention provides a gas discharge lamp driving circuit for supplying a current to the gas discharge lamp, a frequency of said current lying in a predetermined frequency range, the current comprising a number of frequencies in said frequency range, an input power being distributed across said number of frequencies.

A gas discharge lamp driven by a gas discharge lamp driving circuit according to the present invention receives a current being composed of a number of frequencies and possibly having a constant waveform. Thus, the power supplied to the gas discharge lamp is distributed over said number of frequencies. If one or more of said number of frequencies is an acoustic resonance frequency of the gas discharge lamp, the power supplied by said resonance frequency is too little to cause an acoustic resonance in the gas discharge lamp. Even if all the frequencies of said number of frequencies are acoustic resonance frequencies, none of the acoustic resonances will occur, since none of the acoustic resonances is supplied with enough power.

The lamp current may comprise a number of sinusoidal currents having different frequencies in said predetermined frequency range. Thus, the total power is distributed across said number of frequencies.

In another embodiment of the present invention, the current has a non-sinusoidal waveform, the power being distributed across a number of frequencies constituting said waveform, of which a lowest frequency lies in the predetermined frequency range.

A non-sinusoidal waveform may be regarded as being constituted by a number of sinusoidal waves with different frequencies, the number of said waves and the frequencies of said waves being dependent on the waveform. Thus, a non-sinusoidal shaped current has a power distribution wherein the total power is distributed across said number of frequencies. The lowest frequency present in the wave lies in said predetermined frequency range and thus the lowest frequency contributing to the power distribution lies in said predetermined frequency range.

Further, the current may be frequency modulated in order to further reduce the possibility that an acoustic resonance occurs.

The predetermined frequency range may be a high frequency range, i.e. the acoustic resonance range, or the predetermined frequency range may be a very high frequency range, i.e. a frequency range above the acoustic resonance range. Since the power is distributed over a number of frequencies, even in the high frequency range, it is unlikely that an acoustic resonance will occur. However, driving the gas discharge lamp in a very high frequency range further reduces the possibility that an acoustic resonance will occur.

In a specific embodiment of the present invention, the gas discharge lamp driving circuit comprises a half bridge circuit and an output filter. The output filter is connected between a node of the half bridge circuit and a first terminal of the gas discharge lamp. A second terminal of the gas discharge lamp is connected to ground. A first terminal of the half bridge circuit is connected to a supply voltage and a second terminal of the half bridge circuit is connected to ground. Said output filter comprises an inductance and a capacitance connected in series. In this embodiment, the lamp current may be shaped by selecting a value for the capacitance. With a relatively small capacitance, the lamp current is substantially sinusoidal, the power being concentrated at one frequency.

Preferably, the capacitance is large relative to the inductance resulting in such a lamp current that the lamp current comprises a number of frequencies and the power is distributed across said number of frequencies.

These and other aspects of the present invention will be apparent from and elucidated with reference to the embodiments described hereinafter.

The annexed drawings show non-limiting exemplary embodiments, wherein

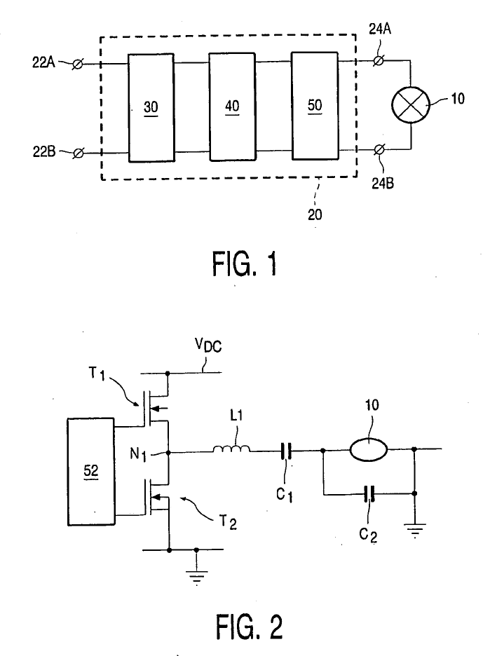

FIG. 1 schematically illustrates a lamp driving circuit for a gas discharge lamp;

FIG. 2 schematically illustrates a half bridge circuit for use in a gas discharge lamp driving circuit according to the present invention;

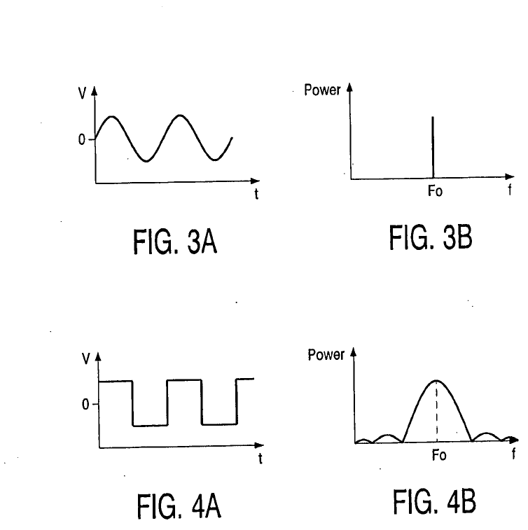

FIG. 3A is a diagram illustrating a sinusoidal current;

FIG. 3B is a diagram illustrating a power distribution of the sinusoidal current of FIG. 3A;

FIGS. 4A and 4B are diagrams illustrating a square wave current and the power distribution thereof, respectively.

In the drawings, identical reference numerals indicate similar components or components with a similar function.

FIG. 1 illustrates a gas discharge lamp 10, for example a high intensity gas discharge (HID) lamp and a lamp driving circuit 20, also known in the art as a ballast 20. To operate the lamp 10, a voltage such as a mains voltage may be supplied to driving circuit input terminals 22A and 22B. The lamp 10 is connected to the lamp driving circuit 20 at output terminals 24A and 24B.

The lamp driving circuit 20 may comprise an input filter 30, a rectifier circuit 40 and an inverter circuit 50. However, the lamp driving circuit 20 may further comprise other circuits, and the lamp driving circuit 20 may not be provided with one or more of the illustrated circuits 40, 50 or filter 30.

In the embodiment illustrated in FIG. 1, the input filter 30 may be an EMI filter, which is a filter known in the art for filtering any disturbing, in particular high frequency, signals from the input voltage. Such a filter may also prevent that high frequency signals are coupled to the circuit supplying said input voltage.

The rectifier circuit 40 transforms an AC voltage, such as a 50 Hz or a 60 Hz mains voltage, to a DC voltage. The rectifier circuit 40 may be a full bridge rectifier circuit well known in the art, possibly provided with one or more capacitors to lower the ripple present in the provided DC voltage. Also, any other circuit suitable for providing a DC voltage may be used. Suitable circuits are well known in the art and are therefore not described in further detail.

The inverter circuit 50 is also a circuit well known in the art of electronic lamp driving circuits, and may comprise a half-bridge circuit with two transistors and a half-bridge driving circuit to control said two transistors. Other types of inverter circuits, such as a full-bridge circuit, may also be used. Using said inverter circuit 50, a controlled AC voltage is output to a load circuit comprising the gas discharge lamp 10.

FIG. 2 illustrates a part of a simple half-bridge embodiment of the inverter circuit 50 and a load circuit comprising the lamp 10. Two transistors T1 and T2 are connected in series between a DC voltage V_{DC} and ground. A half-bridge driving circuit 52 controls said two transistors T1 and T2 to output an AC voltage. At a node N1 between the transistors T1 and T2 a load circuit comprising the gas discharge lamp 10 is connected in order to receive said AC voltage. The load circuit further comprises an inductance L1 and a capacitance C1, both connected in series with the lamp 10 and a capacitance C2 in parallel with the lamp 10.

In the gas discharge lamp 10, an acoustic resonance may occur depending on the frequency, and the power of said frequency, of a lamp current through the lamp 10. Said current is generated by the inverter circuit 50, and is thus dependent on the half-bridge driving circuit 52 controlling the two transistors T1 and T2, and is dependent on the resonant output circuit comprising the capacitors C1 and C2 and the inductance L1.

The acoustic resonance frequency, or frequencies, differs for each gas discharge lamp 10. The differences may be small for a number of gas discharge lamps 10 of the same type and the same manufacturer. The differences may be relatively large between lamps from other manufacturers, for example. The gas discharge lamp driving circuit 20, however, may be the same for these gas discharge lamps 10, as indicated by the output terminals 24A and 24B in FIG. 1, since any suitable lamp 10 may be connected to the lamp driving circuit 20.

To prevent that an acoustic resonance occurs in any of the lamps 10, although these lamps 10 may have different acoustic resonance frequencies, the lamp driving circuit 20 is designed such that the power is distributed over a number of frequencies. The lamp driving circuit 20 is kept simple by keeping the frequency and the shape of the current constant, thereby not requiring any additional hardware to modulate the frequency, for example.

In the embodiment shown in FIG. 2, the frequency of the current is generated and controlled by the half-bridge driving circuit controlling the two transistors T1 and T2. The shape of the current may be selected by selecting a value for the capacitance C1, the capacitance C2 and a value for the inductance L1. Selecting the capacitance C1 relatively small generates a substantially sinusoidal current having one frequency. Selecting the capacitance C1 relatively large with respect to the inductance L1 results in a current shape constituted by a number of sinusoidal frequencies, thus distributing the total supplied power over said number of frequencies.

Since the total power is distributed over said number of frequencies, it is unlikely that there is enough power in one of said number of frequencies to stimulate an acoustic resonance. As will be obvious for a person skilled in the art, the load circuit illustrated in FIG. 2 is only an example and numerous other embodiments are suitable for generating a non-sinusoidal lamp current.

FIG. 3A illustrates a sinusoidal current I as a function of the time t. The current I is an AC current, as indicated by the dashed line indicating the level of zero current.

In FIG. 3B, the power distribution corresponding to the current illustrated in FIG. 3A is shown. The horizontal axis represents a frequency f; the vertical axis represents the amount of power per frequency. Since the current I of FIG. 3A is substantially sinusoidal, the power P is concentrated in only one frequency FO. Such a concentration of power P in one frequency FO may result in an acoustic resonance. To reduce the possibility of an occurring acoustic resonance, a number of such sinusoidal frequencies may be used, thereby reducing the power P in each of said number of frequencies.

Another way of distributing power over a number of frequencies is illustrated in FIGS. 4A and 4B. FIG. 4A illustrates a square wave current I as a function of time t. FIG. 4B illustrates the power distribution corresponding to the square wave current I of FIG. 4A.

A base frequency FO of the square wave (FIG. 4A) is selected to be equal to the frequency of the sinusoidal current I of FIG. 3A. Due to the different shapes of the currents of FIG. 3A and FIG. 4A, the power distributions are different. Whereas FIG. 3B shows a spike at the frequency of the sine wave of FIG. 3A, FIG. 4B shows a curve with a maximum at the base frequency FO, but also a large amount of the power in the current is spread over frequencies both higher and lower than the base frequency FO.

It is noted that the square wave current I illustrated in FIG. 4A is intended as an example to illustrate how power may be distributed over a number of frequencies using a non-sinusoidal current having a constant frequency. In particular, a square wave current distributes the power over a very wide range of frequencies. However, according to the present invention, the lowest powered frequency lies in a predetermined frequency range, such as a high or a very high frequency range, and thus the square wave is not suitable as a non-sinusoidal current according to the present invention.

The frequencies used for driving a gas discharge lamp may lie in a high frequency range or in a very high frequency range. In the high frequency range, less power is dissipated by the driving circuit compared to the very high frequency range, thus providing a more energy efficient driving circuit. The high frequency range, however, is also the range of acoustic resonance. To reduce the possibility of occurrence of acoustic resonance the lamp may be driven in the very high frequency range.

In the above description as well as in the appended claims, ‘comprising’ is to be understood as not excluding other elements or steps and ‘a’ or ‘an’ does not exclude a plurality. Further, any reference signs in the claims shall not be construed as limiting the scope of the invention.

1. A method of operating a gas discharge lamp (10) by supplying a current to the gas discharge lamp (10), a frequency of said current being constant and lying in a predetermined high or very high frequency range, characterized in that the current comprises a number of frequencies in said frequency range, an input power being distributed across said number of frequencies in said predetermined high or very high frequency range.

2. A gas discharge lamp driving circuit for supplying a current to a gas discharge lamp (10), a frequency of said current being constant and lying in a predetermined high or very high frequency range, characterized in that the current comprises a number of frequencies in said frequency range, an input power being distributed across said number of frequencies in said predetermined high or very high frequency range.

3. A gas discharge lamp driving circuit according to claim 2, wherein the current comprises a number of sinusoidal currents having different frequencies.

4. A gas discharge lamp driving circuit according to claim 2, wherein the current has a non-sinusoidal waveform, the power being distributed across a number of frequencies constituting said non-sinusoidal waveform, of which frequencies a lowest frequency lies in said predetermined frequency range.

5. A gas discharge lamp driving circuit according to claim 3, wherein the current is frequency modulated.

6. A gas discharge lamp driving circuit according to claim 2, wherein the gas discharge lamp driving circuit comprises an inverter circuit (50) and an output filter, the output filter being connected between a node of the inverter circuit (N1) and a first terminal of the gas discharge lamp (10), a second terminal of the gas discharge lamp (10) being connected to ground, a first terminal of the inverter circuit being connected to a supply voltage (V_{DC}) and a second terminal of the inverter circuit being connected to ground, the output filter comprising an inductance (L1) and a capacitance (C1) connected in series.

7. A gas discharge lamp driving circuit according to claim 6, wherein the capacitance (C1) is large relative to the inductance (L1) such that the current comprises a number of frequencies and the power is distributed across said number of frequencies.

8. A gas discharge lamp being provided with a gas discharge lamp driving circuit according to claim 2.
